(19) United States
(12) Patent Application Publication
(10) Pub. No.: US 2026/0310533 A1
(43) Pub. Date: Oct. 8, 2026

(54) Fault Engineering Using a Sequence Processing Model

(71) Applicant: Google LLC, Mountain View, CA (US)

(72) Inventors: Harish K Murthy, New York, NY (US); Keshav Kumar, Bengaluru (IN); Aaron Benjamin Sutton, Brooklyn, NY (US); Rohit Sroch, Bangalore (IN)

(21) Appl. No.: 19/642,346

(22) Filed: Apr. 8, 2026

Related U.S. Application Data
(60) Provisional application No. 63/785,390, filed on Apr. 8, 2025.

(51) Int. Cl. G06F 11/00

(52) U.S. Cl. CPC G06F 11/008

(57) ABSTRACT

Systems and methods for fault engineering using sequence processing models can include accessing metadata indicative of one or more computing resources that are associated with a computing system, wherein the metadata includes static metadata and dynamic metadata. The method can include generating, based on the metadata, a dependency graph, wherein the dependency graph includes one or more nodes corresponding to the one or more computing resources that are associated with the computing system. The method can include processing, by a machine-learned model, the dependency graph and a user prompt, wherein the user prompt is associated with a resiliency level of the computing system. The method can include generating, by the machine-learned model, a fault suggestion, wherein the fault suggestion is configured to modify a computing environment of at least one computing resource of the one or more computing resources associated with the computing system.

### FIELD

The present disclosure relates generally to training or controlling an artificial intelligence agent to strategically inject faults into a computing system. More particularly, the present disclosure relates to training or controlling machine-learned models to generate fault suggestions to test the resiliency of computing systems in response to natural language prompts.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes accessing metadata indicative of one or more computing resources that are associated with a computing system, wherein the metadata includes static metadata and dynamic metadata. The method includes generating, based on the metadata, a dependency graph, wherein the dependency graph comprises one or more nodes corresponding to the one or more computing resources that are associated with the computing system. The method includes processing, by a machine-learned model, the dependency graph and a user prompt, wherein the user prompt is associated with a resiliency level of the computing system. The method includes generating, by the machine-learned model, a fault suggestion, wherein the fault suggestion is configured to modify a computing environment of at least one computing resource of the one or more computing resources associated with the computing system.

In some implementations, accessing the metadata includes analyzing configuration data associated with the computing system, wherein the configuration data indicates the one or more computing resources that interact with the computing system. In some implementations, accessing the metadata includes determining, based on the configuration data, the static metadata associated with the computing system.

In some implementations, accessing the metadata includes analyzing traffic data indicative of inbound and outbound data packets between the one or more computing resources that are associated with the computing system. In some implementations, accessing the metadata includes determining, based on the traffic data, dynamic metadata associated with the computing system.

In some implementations, generating, based on the metadata, a dependency graph includes concatenating the static metadata and the dynamic metadata. In some implementations, generating, based on the metadata, a dependency graph includes determining respective node states of the one or more nodes corresponding to the one or more computing resources, wherein the respective node states indicate a level of traffic between each of the one or more nodes.

In some implementations, the method includes determining, based on the respective node states, a relevancy level of each node of the one or more nodes corresponding to the one or more computing resources.

In some implementations, the respective node states are indicative of a relevancy score, the relevancy score computed using one or more scoring algorithms.

In some implementations, the fault suggestion is based on the relevancy score of at least one node of the one or more nodes.

In some implementations, the dependency graph is continuously updated based on the metadata.

In some implementations, the machine-learned model comprises a machine-learned large language model (LLM).

In some implementations, the method includes identifying a resource type associated with each computing resource of the one or more computing resources, wherein the resource type is associated with one or more fault suggestion recipes to modify the computing environment.

In some implementations, the one or more fault suggestion recipes include a modification parameter to modify the computing environment based on the resource type.

In some implementations, the method includes receiving a response to the fault suggestion. In some implementations, the method includes based on the response implementing the fault suggestion to modify the computing environment of the at least one computing resource.

In some implementations, the method includes generating, based on implementing the fault suggestion, fault metrics indicative of a performance of the at least one computing resource within the modified computing environment.

In some implementations, the method includes generating, based on the fault metrics, training data for training the machine-learned model. In some implementations, the method includes training, using the training data, the machine-learned model to generate fault suggestions.

In some implementations, the method includes determining, based on the metadata, a stable state of the computing system, wherein the stable state is indicative of a threshold performance level of the computing system.

Another example aspect of the present disclosure is directed to a computing system. The system can include one or more processors and one or more non-transitory computer-readable media storing instructions that, when implemented, cause the computing system to perform operations. The operations include accessing metadata indicative of one or more computing resources that are associated with a computing system, wherein the metadata includes static metadata and dynamic metadata. The operations include generating, based on the metadata, a dependency graph, wherein the dependency graph includes one or more nodes corresponding to the one or more computing resources that are associated with the computing system. The operations include processing, by a machine-learned model, the dependency graph and a user prompt, wherein the user prompt is associated with a resiliency level of the computing system. The operations include generating, by the machine-learned model, a fault suggestion, wherein the fault suggestion is configured to modify a computing environment of at least one computing resource of the one or more computing resources associated with the computing system.

In some implementations, accessing the metadata includes analyzing configuration data associated with the computing system, wherein the configuration data indicates the one or more computing resources that interact with the computing system. In some implementations, accessing the metadata includes determining, based on the configuration data, the static metadata associated with the computing system.

In some implementations, accessing the metadata includes analyzing traffic data indicative of inbound and outbound data packets between the one or more computing resources that are associated with the computing system. In some implementations, accessing the metadata includes determining, based on the traffic data, dynamic metadata associated with the computing system.

In some implementations, generating, based on the metadata, a dependency graph includes concatenating the static metadata and the dynamic metadata. In some implementations, generating, based on the metadata, a dependency graph includes determining respective node states of the one or more nodes corresponding to the one or more computing resources, wherein the respective node states indicate a level of traffic between each of the one or more nodes.

In some implementations, the operations include determining, based on the respective nodes states, a relevancy level of each node of the one or more nodes corresponding to the one or more computing resources.

In some implementations, the respective node states are indicative of a relevancy score, the relevancy score computed using one or more scoring algorithms.

In some implementations, the fault suggestion is based on the relevancy score of at least one node of the one or more nodes.

In some implementations, the dependency graph is continuously updated based on the metadata.

In some implementations, the machine-learned model comprises a machine-learned large language model (LLM).

In some implementations, the operations include identifying a resource type associated with respective computing resources of the one or more computing resources, wherein the resource type is associated with one or more fault suggestion recipes to modify the computing environment.

In some implementations, the one or more fault suggestion recipes includes a modification parameter to modify the computing environment based on the resource type.

In some implementations, the operations include receiving a response to the fault suggestion. In some implementations, the operations include based on the response implementing the fault suggestion to modify the computing environment of the at least one computing resource.

In some implementations, the operations include generating, based on implementing the fault suggestion, fault metrics indicative of a performance of the at least one computing resource within the modified computing environment.

In some implementations, the operations include generating, based on the fault metrics, training data for training the machine-learned model. In some implementations, the operations include training, using the training data, the machine-learned model to generate fault suggestions.

In some implementations, the operations include determining, based on the metadata, a stable state of the computing system, wherein the stable state is indicative of a threshold performance level of the computing system.

Another example aspect of the present disclosure is directed to a computing system. The system can include one or more processors and one or more non-transitory computer-readable media storing instructions that, when implemented, cause the computing system to perform operations. The operations include accessing metadata indicative of one or more computing resources that are associated with a computing system, wherein the metadata includes static metadata and dynamic metadata. The operations include generating, based on the metadata, a dependency graph, wherein the dependency graph includes one or more nodes corresponding to the one or more computing resources that are associated with the computing system. The operations include processing, by a machine-learned model, the dependency graph and a user prompt, wherein the user prompt is associated with a resiliency level of the computing system. The operations include generating, by the machine-learned model, a fault suggestion, wherein the fault suggestion is configured to modify a computing environment of at least one computing resource of the one or more computing resources associated with the computing system.

In some implementations, accessing the metadata includes analyzing configuration data associated with the computing system, wherein the configuration data indicates the one or more computing resources that interact with the computing system. In some implementations, accessing the metadata includes determining, based on the configuration data, the static metadata associated with the computing system.

In some implementations, accessing the metadata includes analyzing traffic data indicative of inbound and outbound data packets between the one or more computing resources that are associated with the computing system. In some implementations, accessing the metadata includes determining, based on the traffic data, dynamic metadata associated with the computing system.

In some implementations, generating, based on the metadata, a dependency graph includes concatenating the static metadata and the dynamic metadata. In some implementations, generating, based on the metadata, a dependency graph includes determining respective node states of the one or more nodes corresponding to the one or more computing resources, wherein the respective node states indicate a level of traffic between each of the one or more nodes.

In some implementations, the operations include determining, based on the respective nodes states, a relevancy level of each node of the one or more nodes corresponding to the one or more computing resources.

In some implementations, the respective node states are indicative of a relevancy score, the relevancy score computed using one or more scoring algorithms.

In some implementations, the fault suggestion is based on the relevancy score of at least one node of the one or more nodes.

In some implementations, the dependency graph is continuously updated based on the metadata.

In some implementations, the machine-learned model comprises a machine-learned large language model (LLM).

In some implementations, the operations include identifying a resource type associated with respective computing resources of the one or more computing resources, wherein the resource type is associated with one or more fault suggestion recipes to modify the computing environment.

In some implementations, the one or more fault suggestion recipes includes a modification parameter to modify the computing environment based on the resource type.

In some implementations, the operations include receiving a response to the fault suggestion. In some implementations, the operations include based on the response implementing the fault suggestion to modify the computing environment of the at least one computing resource.

In some implementations, the operations include generating, based on implementing the fault suggestion, fault metrics indicative of a performance of the at least one computing resource within the modified computing environment.

In some implementations, the operations include generating, based on the fault metrics, training data for training the machine-learned model. In some implementations, the operations include training, using the training data, the machine-learned model to generate fault suggestions.

In some implementations, the operations include determining, based on the metadata, a stable state of the computing system, wherein the stable state is indicative of a threshold performance level of the computing system.

Other example aspects of the present disclosure are directed to other systems, methods, apparatuses, tangible non-transitory computer-readable media, and devices for performing functions described herein.

These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

For instance, aspects of the present disclosure can provide for a number of technical effects and benefits such as reducing the computational resources of machine-learned models, improving the information quality available to users, and efficiently decoding diverse outputs of machine-learned models in a single call as further described herein.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system according to example embodiments of the present disclosure;

FIG. 2 depicts a block diagram of an example computing system according to example embodiments of the present disclosure;

FIG. 3 depicts a block diagram of an example dataflow pipeline according to example embodiments of the present disclosure;

FIG. 4 depicts a block diagram of an example dataflow pipeline according to example embodiments of the present disclosure;

FIG. 5 depicts a flow chart diagram of an example method to generate efficient communications according to example embodiments of the present disclosure;

FIG. 6 is a flow chart diagram illustrating an example method for training a machine-learned model according to example implementations of aspects of the present disclosure;

FIG. 7 is a block diagram of an example processing flow for using machine-learned model(s) to process input(s) to generate output(s) according to example implementations of aspects of the present disclosure;

FIG. 8 is a block diagram of an example sequence processing model according to example implementations of aspects of the present disclosure;

FIG. 9 is a block diagram of an example technique for populating an example input sequence for processing by a sequence processing model according to example implementations of aspects of the present disclosure;

FIG. 10 is a block diagram of an example model development platform according to example implementations of aspects of the present disclosure;

FIG. 11 is a block diagram of an example training workflow for training a machine-learned model according to example implementations of aspects of the present disclosure;

FIG. 12 is a block diagram of an inference system for operating one or more machine-learned model(s) to perform inference according to example implementations of aspects of the present disclosure;

FIG. 13 is a block diagram of an example networked computing system according to example implementations of aspects of the present disclosure;

FIG. 14 is a block diagram of an example computing device according to example implementations of aspects of the present disclosure; and

FIG. 15 is a block diagram of an example computing device according to example implementations of aspects of the present disclosure.

Reference numerals that are repeated across plural figures are intended to identify the same features in various implementations.

### DETAILED DESCRIPTION

Generally, the present disclosure is directed to systems and methods for fault engineering using machine-learned sequence processing models such as large language models (LLMs). More particularly, one challenge existing in the field of fault engineering for computing systems is that a deep understanding of the underlying computing system infrastructure is a prerequisite to inject faults that robustly test resiliency against various conditions which can occur in a production computing environment. Fault engineering may include the practice of identifying points of failure within a computing system or the underlying infrastructure of the computing system for the purpose of intentionally injecting faults to test the impact or resiliency of the computing system. Observations resulting from fault injections may be used to reduce or eliminate the point of failure and build confidence in the ability of the computing system to handle issues that may arise in a production computing environment.

For example, a computing system which includes multiple computing resources and interacts with other computing systems over a network may be subject to numerous points of failure. For instance, each individual computing resource of the computing system, the computing resources associated with the other computing system, or the network itself may individually or collectively be a point of failure for a computing system.

In some examples, the process of identifying all computing resources (e.g., discovery) associated with a computing system may also be problematic. For instance, distributed or large computing systems which include hundreds or thousands of interconnected devices, nodes, etc., may be difficult to trace in a centralized manner. Moreover, even a static list of computing systems, computing resources, and network configurations may be insufficient to understand appropriate points of failure. For example, the relationships between different computing systems and computing resources within the underlying infrastructure serves as an additional prerequisite to accurately identify points of failure and inject faults appropriately. Thus, another technical problem in the field of fault engineering is discovery and comprehension of complex relationships within the infrastructure of computer systems.

In view of the above challenge, the systems and methods described herein can provide for techniques for improved discovery, fault injection, and fault detection by automating discovery and removing the prerequisite of deep technical knowledge of the underlying computing infrastructure. In particular, in some examples, a user may interact with an interface (e.g., user interface display, etc.) to provide a user prompt inquiring about one or more aspects of a computing system. For instance, the user may provide a user prompt requesting information associated with a resiliency level of the computing system. In some examples, the user prompt may include natural language text. In an embodiment, the user prompt may be spoken audio data that is transcribed into natural language text.

Prior to or in response to the user prompt, a discovery process may be initialized to determine a static composition of the computing system. The static composition may include metadata which identifies the computing resources (e.g., elements) associated with the computing environment (e.g., cloud, on-premise, other infrastructure, etc.) of the computing system. By way of example, an organization’s computing system may include a folder structure (e.g., organization folders) which organize applications, computing resources, for a particular organization. For instance, a folder may contain multiple projects, and within each project multiple computing resources such as virtual machines, load balancers, object stores, etc. may be utilized. Accordingly, the discovery process may include accessing static metadata to discover the composition of the computing system by identifying all computing systems, sub-systems, computing resources, etc.

In an embodiment, accessing metadata may include parsing configuration files, source code, etc. to identify computing resources. In some embodiments, the static metadata may indicate a hierarchy of composition associated with a computing system. A hierarchy can indicate relationships between top level computing resources, projects, etc., and subdirectories, files, etc.

In some embodiments, the discovery process may additionally and/or alternatively include accessing dynamic metadata. For instance, static metadata may include a static inventory list as a baseline composition of the computing system. However, the static metadata may not include information indicating associations or relationships between elements (e.g., computing resources, computing systems, etc.). Dynamic metadata may include data (e.g., logs files, etc.) which indicate a flow of data or information within the computing systems. For instance, computing processes including multiple elements may generate a flow of data, requests, commands, across a network to facilitate functionality of the computing system.

For example, two virtual machines communicating with each other across a network may generate network traffic as data, requests, etc. are iteratively processed and transmitted. In an embodiment, dynamic metadata may include flow logs indicating the flow of data between elements of the computing system. For example, in a cloud computing environment virtual private cloud (VPC) flow logs (e.g., and/or equivalents) may be accessed to supplement the static composition of the computing system. In an embodiment, the dynamic metadata may overlay on top of the static metadata to build or enrich relationships between resources indicating the nature, frequency, relevancy , etc. of communications.

By way of example, a computing system which includes ten virtual machines (VMs) may utilize nine of the ten VMs for hosting applications and utilize one VM to serve as a firewall. In this example, the static metadata may only indicate that there are ten VMs in a particular project. In turn, this may cause difficulties in identifying points of failure to intelligently inject engineered faults absent additional understanding of the relationships between the ten VMs. In some embodiments, the dynamic metadata (e.g., VPC flow logs, etc.) may be concatenated with the static metadata to supplement the compositional structure of the computing system. Concatenating the dynamic metadata and static metadata may include associating elements across static resource lists, etc., with live or dynamic log data. For instance, concatenating the static and dynamic metadata may provide insights indicating that all the traffic for the particular project is going through one VM serving as the firewall prior to being distributed to the remaining nine VMs which are hosting applications.

In an embodiment, a dependency graph may be generated based on the metadata (e.g., static and/or dynamic metadata). The dependency graph may include a visualized depiction of the composition of the computing system. For instance, the dependency graph may depict a graph-like structure that indicates the static composition (e.g., all computing resources, computing systems, sub-systems, etc.) associated with the computing system. In some embodiments, the dependency graph may additionally and/or alternatively depict dynamic metadata that indicates relationships between elements (e.g., flow of traffic, data, etc.). For example, the dependency graph may include a series of nodes and edges where the nodes represent elements and the edges represent relationships between the elements.

By way of example, the dependency graph may depict that the computing system includes ten VMs where the traffic flows through one VM (e.g., firewall VM) and uses nine VMs to host applications. For example, each of the ten VMs may be depicted as a node where one node represents the firewall VM, and the other nine nodes represent the nine VMs. Edges between the ten nodes may represent the flow of traffic from the firewall node to the other nine nodes. While examples, described herein discuss edges and nodes to represent the static and dynamic composition of a computing system, the present disclosure is not limited to such embodiment, and any form of graphical depiction may be used to visualize the computing system.

In some embodiments, the dependency graph may be displayed to the user via the user interface. For instance, in response to the use prompt, the dependency graph may be displayed to display the composition of the computing system. In some embodiments, the dependency graph may be interactive. For instance, the user may provide user input via the user interface to interact with one or more elements (e.g., nodes, edges, etc.) to analyze additional data associated with the computing system. In some examples, user interactions with the dependency graph may facilitate prompt expansion where the initial user prompt is supplemented with additional context, additional prompts, or updated prompt based on the user’s interaction with the dependency graph.

In another embodiment, the dependency graph may be further supplemented. For instance, each element (e.g., node, edge, etc.) may be weighted and/or scored. For example, weights and/or scores may indicate a level of relevancy or importance of the node (e.g., element) or edge (e.g., communication channel, etc.). One or more algorithms, machine-learned models, etc., may be used to build weights or score the nodes and edges.

By way of example, the firewall node may indicate a single point of failure for the nine other downstream nodes due to the firewall node serving as a firewall which distributes traffic. As such, the firewall node may be weighted or scored higher than the other nodes. Similarly, the edges connected to the firewall node may also be weighted or scored higher than other edges due to the inbound and outbound traffic for the applications hosted on the nine nodes being proxied through the firewall node. In this manner, the dependency graph may indicate more critical (e.g., relevant) nodes, edges, etc., that cause greater risk to the computing system.

In an embodiment, a machine-learned large language model (LLM) may process the user prompt, expanded prompt, modified prompt, etc., requesting information associated with a resiliency level of the computing system and the dependency graph to generate as output one or more fault suggestions. The LLM may be a generative machine-learned model. For example, a generative model may include a sequence processing model. A sequence processing model can be configured to individually process natural language and generate a sequence of tokens.

As one example, the sequence of tokens can be or can include text data such as words, and/or the sequence of tokens can collectively form a passage or block of text that is displayed to the user via the user interface. The sequence of tokens can, for instance, collectively describe an answer or response to the user’s input. For instance, the sequence of tokens may include a natural language response to the user prompt indicating a suggested fault suggestion.

Furthermore, in some implementations, the plurality of tokens can be or can include (e.g. or can be converted to) spoken language data such as audio data that can be spoken to the user. In some implementations, the generative models can output values, such as confidence scores or certainty scores, tonality scores, and/or other suitable scores and/or values, which are respectively associated with the plurality of tokens.

By way of example, the LLM may generate, based on the dependency graph, one or more fault suggestions to provide to the user in response to the user prompt. For instance, the LLM may decode a natural language response describing the critical (e.g., relevant) nodes and edges (e.g., computing resources, data flows, etc.) within the computing system to the user and suggesting one or more faults to inject into the computing system. In an embodiment, the fault suggestions may be based on fault recipes associated with elements identified as being critical (e.g., relevant).

For example, each of the elements (e.g., nodes) represented in the dependency graph may be associated with a resource type. A resource type may indicate a classification or category of computing resource which provides functionality or services to the computing system. Various types of computing resources may provide different, complementary, and/or supplementary functionality for the computing system. Based on the resource type, fault recipes may be determined to test the particular type of resource type.

For instance, the firewall node may be tagged as a firewall resource type and one example fault recipe for testing the firewall resource type may include a volumetric attack such as HTTP/HTTPs floods consisting of millions of valid sessions. The fault recipe can be injected into the firewall node to test the resiliency of the firewall element within the computing system for withstanding a volumetric attack. In some embodiments, the fault recipe may also test the overall impact that a particular type of fault recipe for a resource type has on the overall computing system. For instance, the volumetric fault recipe injected into the firewall node may cause traffic to slow or terminate to the other nine nodes negatively impacting performance or causing an outage.

In another example, one of the nine nodes may be tagged as a virtual machine (VM) resource type. Fault recipes for a VM resource type may include, but are not limited to dropping all inbound traffic, shutting down the VM, redirecting traffic, introducing latency, introducing jitter in network packets, etc. The fault recipe can be injected into the nodes to observe impacts, generate metrics, etc. While examples herein describe specific examples of resource types and fault recipes, the present disclosure is not limited to such embodiment. Any classification of computing resources may be used and various mechanisms for testing types of different classifications of computing resources may be implemented.

The LLM may generate fault suggestions which include one or more fault recipes associated with elements of the computing system that are identified as being a point of failure. For example, the LLM may generate a fault suggestion to test the firewall node based on the dependency graph indicating that the firewall node is the most critical (e.g., relevant) node due to all traffic for the computing system being proxied through that as a single point of failure. The fault suggestion may be presented back to the user (e.g., as natural text) as an option to inject into the computing system.

In some embodiments, the user may provide user input responding to the fault suggestion and indicating an intent to inject the computing system with the suggested prompt. For instance, the fault suggestion may modify the computing environment of the firewall node by simulating a volumetric attack. In some embodiments, metric data may be captured which measures the performance of the firewall node, other nodes, edges, etc. in response to modifying the computing environments. The metric data may be used to update the dependency graph in real-time, generate performance visualizations, or used as a feedback loop for the LLM.

For example, the LLM may be trained to generate accurate fault suggestions for a particular computing system based on receiving feedback data (e.g., metric data etc.) indicating how well the LLM performed at predicting the most critical (e.g., relevant) points of failure to form the basis of a fault suggestion. In this manner, the LLM may incrementally improve the resiliency of computing systems over time and adapt and/or adjust to changes in the underlying infrastructure by receiving feedback from previous fault suggestions.

Example aspects of the present disclosure can provide for a number of technical effects and benefits, including improvements in the field of chaos engineering. As one example, by utilizing an LLM to construct the requisite domain knowledge for computing systems, the barriers to entry for users intending to increase confidence in computing systems will be reduced. For instance, even non-technical users or users without deep technical knowledge of computing systems or computing system infrastructure will be able to make informed decisions with respect to fault injections. This in turn causes computing systems to become more resilient to varying conditions, points of failure, etc. faster and more efficiently.

In another example, aspects of the present disclosure can provide for improvements to computer technology. For example, systems and methods described herein can dynamically adjust to an increase or change in computing resources for a computing system and provide accurate fault injection suggestions. The increase in accuracy of fault injection suggestions exposes critical (e.g., relevant) points of failure faster before issues arise. This increases the overall stability of computing resources preventing disruptions, poor performance, or even outages. Moreover, exposing points of failure may also preserve computing resources of computing systems. For instance, computing systems may avoid expending computing resources to react to conditions in production by being better prepared to facilitate operations of the computing system in the event of a live fault.

With reference now to the Figures, example embodiments of the present disclosure will be discussed in further detail.

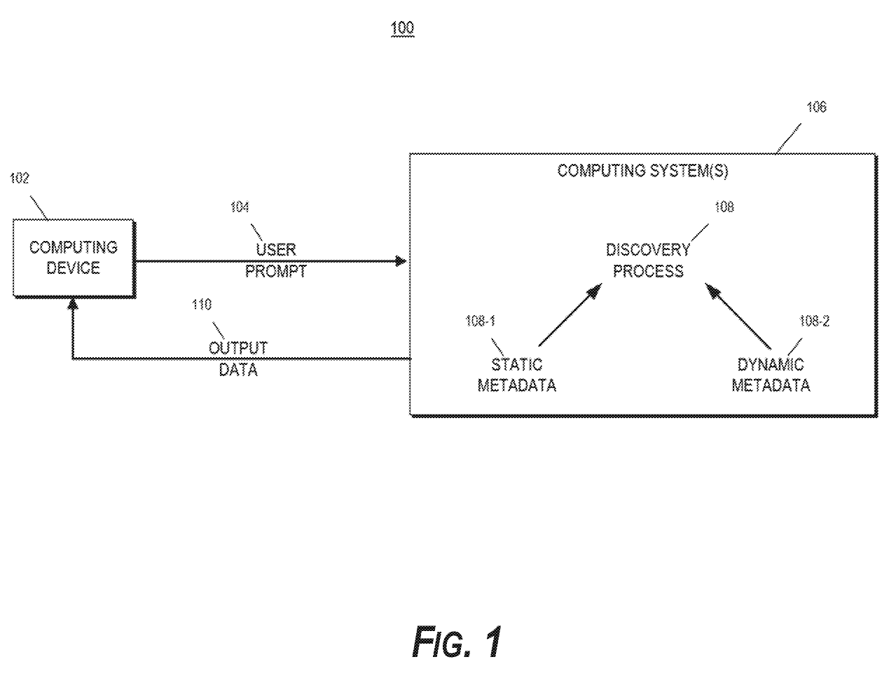

FIG. 1 depicts a block diagram of an example computing system ecosystem 100 according to example embodiments of the present disclosure. In some implementations, the computing ecosystem 100 is configured to facilitate fault engineering. For instance, a user associated with a user computing device 102 may provide a user prompt 104 inquiring about a resiliency level of a computing system 106. In response to the user prompt 104 a discovery process 108 may be initialized to construct a composition of the computing system 106. For example, static metadata 108-1 and dynamic metadata 108-2 may be accessed to identify computing resources and relationships between computing resources associated with the computing system 106.

In some implementations, the computing ecosystem 100 may be or otherwise include a generative model system configured to facilitate a fault engineering process of the computing system 106. A generative model system may include any computing system which includes the computing system 106 and an interface (e.g., user interface, API, user computing device etc.) that allows a user associated with the computing device 102 to interact with the computing system 106. The interface may be configured to present outputs (e.g., output data 110) derived from data associated with the computing system 106, present user interface elements, or otherwise facilitate the fault engineering process.

The computing device 102 may include a mobile computing device, such as a smartphone, tablet computer, laptop computer, VR or AR headset device, and the like. As such, the computing device 102 may include components such as a microphone, a camera, a satellite receiver, and a communication interface to communicate with external entities using any number of wireless communication protocols. In some examples, the computing device 102 may store applications executable by one or more processors of the computing device 102, enabling access and interaction with the computing system 106 over one or more networks.

The computing device 102 may be associated with a user and allow the user to generate one or more user prompts 104. User prompts 104 may include natural language text such as a request, question, statement, or message that invokes a response. In an embodiment, the user prompt 104 may be spoken audio data that is transcribed into natural language text. By way of example, the user prompt 104 may include a request for information associated with a resiliency level of the computing system 106.

The computing system 106 may include one or more systems which correspond to production or staging environments that are a target for fault engineering and resiliency analysis. In some implementations, the infrastructure associated with the computing system 106 may be implemented using on-premise hardware, a cloud computing platform (e.g., a serverless computing service, a virtual machine hosting service, etc.), or a hybrid environment. For instance, the computing system 106 may be configured to host core application components. As one example, such components can perform the fault analysis and may include the discovery process 108.

For instance, based on the user prompt 104, the computing system 106 may be configured to initialize a discovery process 108 to determine a static composition of the computing system 106. The static composition may include metadata which identifies the computing resources (e.g., elements) associated with the computing environment (e.g., cloud, on-premise, other infrastructure, etc.) of the computing system 106.

By way of example, the computing system 106 may be associated with an entity or organization which facilitates a plurality of processes, workflows, or data pipelines. The computing system 106 may use or otherwise process data (e.g., inputs, stored data, etc.) to perform operations or otherwise generate outputs. In some implementations, the computing system 106 may include a folder structure (e.g., organization folders) which organize applications or computing resources that are used for facilitating the entities’ processes.

For instance, a folder may contain multiple tasks, and within each task multiple computing resources such as virtual machines, load balancers, object stores, etc. may be utilized. Accordingly, the discovery process 108 may include accessing static metadata 108-1 to discover the composition of the computing system 106 by identifying all computing infrastructure, sub-systems, computing resources, etc. that are associated with each task.

In some implementations, the discovery process 108 may include parsing static metadata 108-1 such as configuration files, source code, etc. to identify computing resources within the computing system 106 (e.g., or external to the computing system 106). In this manner, the static metadata 108-1 may indicate a hierarchy of composition associated with specific tasks, projects, or processes of the computing system 106 or the computing system 106 as a whole. A hierarchy may also indicate relationships between top level computing resources, projects, tasks, etc., and subdirectories, files, etc.

The discovery process 108 may additionally and/or alternatively include accessing dynamic metadata 108-2. For instance, static metadata 108-1 may include a static inventory list as a baseline composition of the computing system 106. However, the static metadata 108-2 may not include information indicating associations or relationships between elements (e.g., computing resources, sub-systems, infrastructure, etc.). Dynamic metadata 108-2 may include data (e.g., logs files, etc.) which indicate a flow of data or information within the computing system 106. For instance, computing processes including multiple elements may generate a flow of data, requests, commands, across a network to facilitate functionality of the computing system 106.

By way of example, clusters communicating with each other across a network may generate network traffic as data, requests, etc. are iteratively processed and transmitted. In an embodiment, dynamic metadata 108-2 may include flow logs indicating the flow of data between elements of the computing system 106. For example, in a cloud computing environment virtual private cloud (VPC) flow logs (e.g., and/or equivalents) may be accessed to supplement the static composition of the computing system. In an embodiment, the dynamic metadata 108-2 may overlay on top of the static metadata 108-1 to build or enrich relationships between resources indicating the nature, frequency, relevancy , etc. of communications.

By way of example, a computing system which includes seven virtual machines (VMs) may utilize five of the seven VMs for hosting applications and utilize one VM to serve as a firewall. In this example, the static metadata 108-1 may only indicate that there are seven VMs in a particular project. In turn, this may cause difficulties in identifying points of failure to intelligently inject engineered faults absent additional understanding of the relationships between the seven VMs. In some embodiments, the dynamic metadata 108-2 (e.g., VPC flow logs, etc.) may be concatenated with the static metadata 108-1 via the discovery process 108 to supplement the compositional structure of the computing system 106. Concatenating the dynamic metadata 108-2 and static metadata 108-1 may include associating elements across static resource lists, etc., with live or dynamic log data. For instance, concatenating the static and dynamic metadata may provide insights indicating that all the traffic for the particular project (e.g., or computing system 106) is going through one VM serving as the firewall prior to being distributed to the remaining five VMs which are hosting applications.

In an embodiment, the computing system 106 may generate output data 110 responsive to the user prompt 104. For instance, the computing ecosystem 100 may be an agent system that can employ one or more machine-learned models (e.g., generative models, etc.) to generate outputs (e.g., output data 110) responsive to user prompts 104. An agent system (e.g., an “artificial intelligence agent” or “AI agent”) can employ one or more machine-learned models (e.g., generative models, etc.) to generate output data 110 (e.g., images, text, audio, etc.) responsive to user prompts 104 or input data from users (e.g., computing device 102) as a part of a fault engineering process. As one example, an agent system can be or can include a computing system including one or more machine-learned token generation models, where the computing system is configured to receive an input from a user device or calling device and provide output data 110 including a plurality of tokens that are responsive to the input (e.g., user prompt 104) to the computing device 102 or calling device. As one example, the plurality of tokens can be or can include text data such as words, and/or the plurality of tokens can collectively form a passage or block of text that is displayed to the user associated with the computing device. The plurality of tokens can, for instance, collectively describe an answer or response to the user prompt.

Furthermore, in some implementations, the plurality of tokens can be or can include (e.g. or can be converted to) spoken language data such as audio data that can be spoken to the user. In some implementations, the generative models can output values, such as confidence scores or certainty scores, tonality scores, and/or other suitable scores and/or values, which are respectively associated with the plurality of tokens.

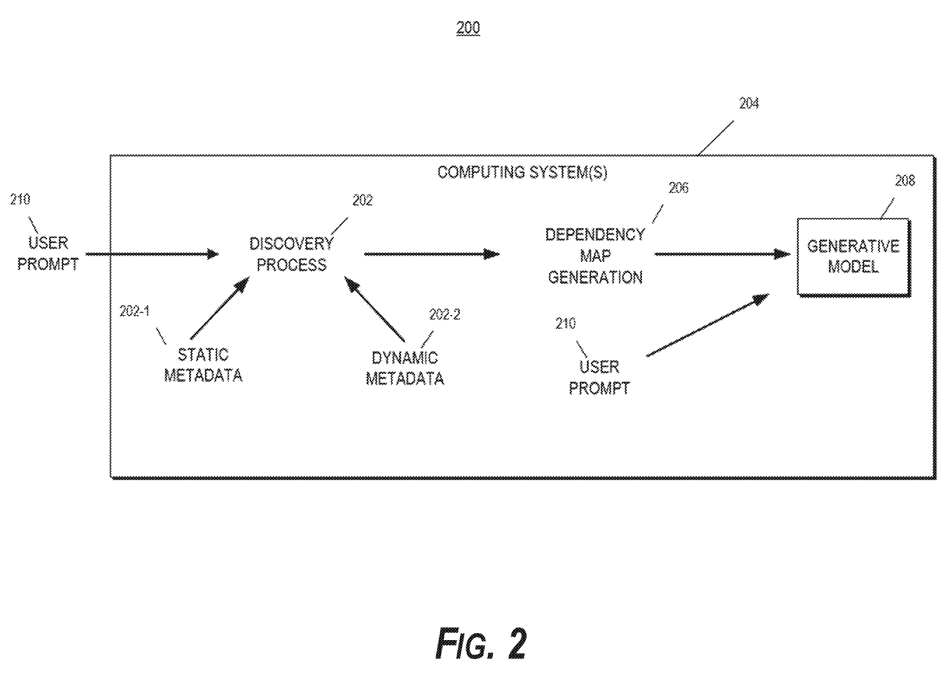

In some implementations, the agent system can be or can implement a multi-modal agent (e.g., a multi-modal artificial intelligence agent). For instance, a multi-modal agent can process inputs from one or more data modalities. In some implementations, the agent system can be implemented as a “situated agent”. For example, the computing system 106 may include a “situated agent” which generates a series of output data 110 and transmits the output data to the computing device 102. An example of the computing system 106 including generative models is further described with reference to FIGS. 2-4.

In this example, output data 110 may include a natural language response to the user prompt 104 by providing information associated with the resiliency level of the computing system 106. In some implementations, the computing system 106 may utilize the output of the discovery process 108 to generate a dependency graph. The dependency graph may include a visual representation of the composition of the computing system 106 and/or the resiliency level of the computing system 106. An example of a dependency graph is further described with reference to FIGS. 2-4.

FIG. 2 depicts a block diagram of an example computing ecosystem according to example embodiments of the present disclosure. The computing ecosystem 200 is similar to the computing ecosystem 100 of FIG. 1 except that computing ecosystem 200 further includes a dependency map generation 206 process and a generative model 208.

In particular, the computing ecosystem 200 can facilitate fault engineering using the computing system 204. For instance, the computing system 204, in response to the user prompt 210 may initialize the discovery process 202 to access static metadata 202-1 and dynamic metadata 202-2. The static metadata 202-1 and dynamic metadata 202-2 may be used to initialize a dependency map generation 206 process to generate a dependency map indicating the composition of the computing system 204. The dependency map and the user prompt 210 may be input into the generative model 208 to generate output responsive to the user prompt 210.

The computing system 204 may be similar to the computing system 106 of FIG. 1. For instance, the computing system 204 may correspond to production or staging environments that are a target for fault engineering and resiliency analysis. The infrastructure associated with the computing system 204 may be implemented using on-premise hardware, a cloud computing platform (e.g., a serverless computing service, a virtual machine hosting service, etc.), or a hybrid environment, can be configured to host core application components. In this example, such components can perform the analysis and can include a discovery process 202, a dependency map generation 206 process, and a generative model 208. For instance, the computing system 204 can be configured to perform operations to determine a baseline operational level for the computing system 204.

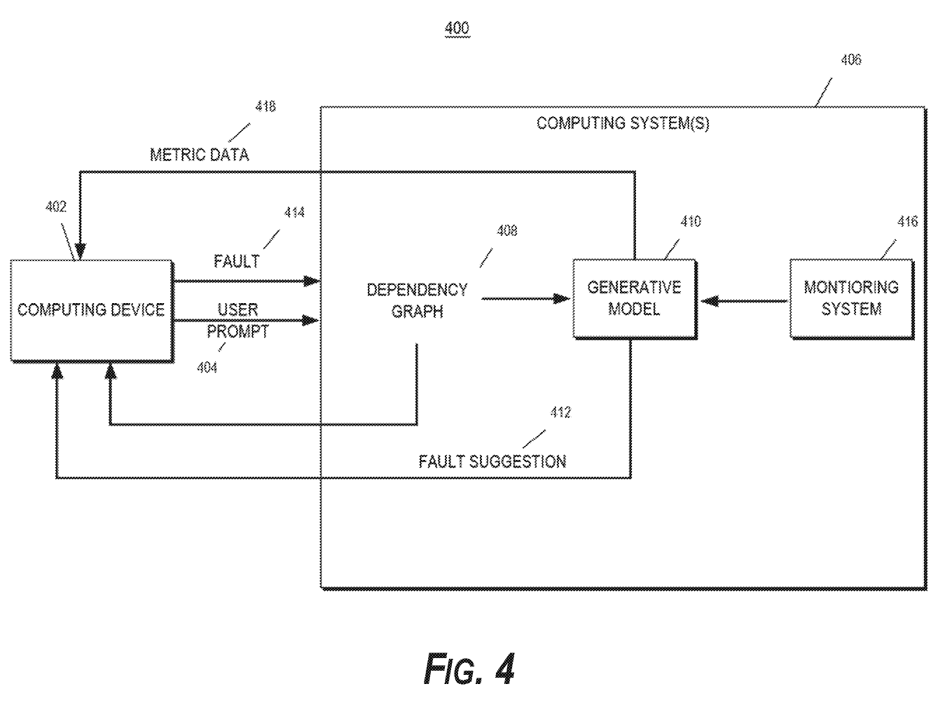

By way of example, the computing system 204 may be configured to determine, based on metadata collected from the computing system 204 via the discovery process 202, a stable state of the computing system 204. The stable state can be indicative of a threshold performance level, providing a benchmark against which the effects of subsequent fault injections can be measured. An example of fault injections is further described with reference to FIG. 4.

The discovery process 202 may be similar to the discovery process 108 of FIG. 1. For instance, the discovery process 202 may be initialized in response to or based on the user prompt 210. Additionally, or alternatively, the discovery process 202 may be initialized prior to (e.g., in anticipation of) receiving the user prompt 210.

The discovery process 202 may include accessing metadata indicating computing resources associated with the computing system 204. The accessed metadata can include, for example, both static metadata 202-1 and dynamic metadata 202-2. The static metadata 202-1 and dynamic metadata 202-2 may be similar to the static metadata 108-1 and dynamic metadata 108-1 of FIG. 1. For instance, accessing or obtaining the static metadata 202-1 may include performing an analysis of one or more configuration files associated with the computing system 204, such as by parsing infrastructure-as-code files or querying a cloud asset inventory. As previously described, the static metadata 202-1 can define an intended architecture and resource relationships.

Similarly, accessing or obtaining the dynamic metadata 202-2 may include analyzing traffic data indicating inbound and outbound data packets between the one or more computing resources. For instance, the discovery process 202 can ingest and process network flow logs (e.g., Virtual Private Cloud (VPC) flow logs) or audit logs to determine the dynamic metadata 202-2, indicating operational interactions.

In some implementations, the computing system 204 may generate or initialize a data processing pipeline for a dependency map generation 206 process. The dependency map generation 206 may include a process of processing, analyzing, aggregating, or otherwise utilizing the collected metadata to generate a dependency graph. For instance, the dependency map generation 206 may include concatenating the static metadata 202-1 and the dynamic metadata 202-2 to form a comprehensive data set. This data set can then be processed to construct a dependency graph.

The dependency graph may be the output of the dependency map generation 206 based on the metadata (e.g., static and/or dynamic metadata). The dependency graph may include a visualized depiction of the composition of the computing system 204. For instance, the dependency graph may depict a graph-like structure that indicates the static composition (e.g., all computing resources, computing systems, sub-systems, etc.) and the dynamic composition (e.g., dataflows, relationships, significance levels) of each of the computing resources associated with the computing system 204.

In some implementations, the dependency graph may be or otherwise be stored and managed within a graph database (e.g., a graph-oriented data store). In some implementations, the dependency graph can be updated based on incoming metadata to maintain a current representation of the computing system 204. For instance, the dependency graph may include one or more nodes corresponding to computing resources, infrastructure, sub-systems, etc., and edges indicating the relationships between the computing resources. Based on the concatenated (e.g., fused) metadata (e.g., static metadata 202-1, dynamic metadata 202-2, etc.), the computing system 204 can determine respective node states of the one or more nodes, where the respective node states can indicate a level of traffic between each of the one or more nodes.

By way of example, the computing system 204 may be configured to determine, based on the respective node states, a significance level for each node. For instance, the node states can be indicative of a significance score, which can be computed using one or more scoring algorithms. In another example, a graph algorithm (e.g., a PageRank algorithm, a centrality measure algorithm, etc.) can be applied to the dependency graph to calculate a significance score for each node. This may provide a quantitative measure of impact for each computing resource based on the volume and nature of the dependencies.

The dependency graph and the user prompt 210 may be input into the generative model 208. The generative model 208 can be any suitable model. For example, in some implementations, the generative model 208 can be or can include an image generation model. The image generation model can be configured to generate media data such as natural or non-natural images. Examples of an image generation model can include but is not limited to a vision language model (VLM). For instance, the image generation model may generate, refine, or modify images in response to requests or prompts. By way of example, the generative model 208 may generate an image of the dependency graph as output responsive to the user prompt 210.

In some implementations, the generative model 208 can be or can include a sequence processing model. The sequence processing model can be configured to individually generate a sequence of tokens. Examples of a sequence processing model include, but are not limited to, a large language model (LLM) or a large multimodal model (LMM). For instance, the sequence processing model may generate tokens in a sequential manner.

In an embodiment, the computing ecosystem 200 may be an agent system that can employ one or more machine-learned models (e.g., generative models, etc.) to generate outputs responsive to user prompts 210 or other input data. An agent system (e.g., an “artificial intelligence agent” or “AI agent”) can employ one or more machine-learned models (e.g., generative models, etc.) to generate outputs (e.g., images, text, audio, etc.) responsive to user prompts 210 or other input data as a part of a multi-turn interaction. As one example, an agent system can be or can include a computing system including one or more machine-learned token generation models, where the computing system is configured to receive an input from a user device (e.g., computing device) or calling device and provide an output including a plurality of tokens that are responsive to the input to the user device or calling device. As one example, the plurality of tokens can be or can include text data such as words, and/or the plurality of tokens can collectively form a passage or block of text that is displayed to the user. The plurality of tokens can, for instance, collectively describe an answer or response to the user’s input.

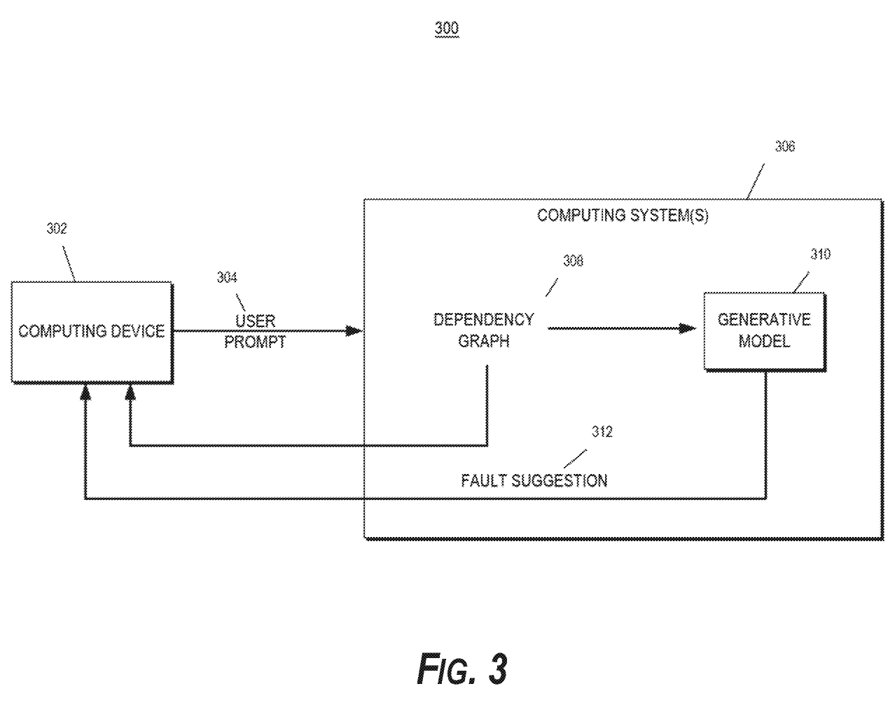

In some implementations, the plurality of tokens may include a fault suggestion. The fault suggestion may include a natural language output that provides the user with one or more suggestions to test the resiliency of the computing system 204 based on the discovery process 202, dependency graph, etc. An example of a fault suggestion is further described with reference to FIGS. 3-4.

FIG. 3 depicts a block diagram of an example dataflow pipeline according to example embodiments of the present disclosure. Dataflow pipeline 300 is described with an example implementation in which a computing device 302 transmits a user prompt 304 to the computing system 306, and in response to the user prompt 304, generates a dependency graph 308 detailing the composition of the computing system 306. The user prompt 304 and the dependency graph 308 may be input into a generative model 310 to generate one or more fault suggestions 312 indicating an engineered (e.g., synthetic) fault that may be injected into the computing system 306 to test a level of resiliency associated with one or more elements of the computing system 306.

Although FIG. 3 depicts steps performed in a particular order for purposes of illustration and discussion, the methods of the present disclosure are not limited to the particularly illustrated order or arrangement. The various steps of dataflow pipeline 300 can be omitted, rearranged, combined, and/or adapted in various ways without deviating from the scope of the present disclosure.

The computing device 302 may be similar to the computing device 102 of FIG. 1. For instance, the computing device 302 may include a mobile computing device, such as a smartphone, tablet computer, laptop computer, VR or AR headset device, and the like. As such, the computing device 302 may include components such as a microphone, a camera, a satellite receiver, and a communication interface to communicate with external entities using any number of wireless communication protocols. The computing device 302 may be associated with a user and allow the user to generate one or more user prompts 304.

The user prompt 304 may be similar to the user prompt 104 of FIG. 1. For instance, user prompts 304 may include natural language text such as a request, question, statement, or message that invokes a response. In this example, the user prompt 304 may include a request for assistance in testing the resiliency of the computing system 306.

Based on the user prompt 304, the computing system 306 may generate a dependency graph 308. The dependency graph 308 may be the output of a dependency map generation process based on metadata (e.g., static and/or dynamic metadata) associated with the computing system 306. In some implementations, the dependency graph 308 may be generated by another (e.g., remote computing system) and provided to the computing system 306. For instance, in a cloud environment, cloud infrastructure may be managed separately or independently of the computing system 306 where metadata associated with computing resources, relationships, etc. is provided to the computing system 306 by way of API or other communication channels. In this example, the dependency graph 308 may be accessed based on the user prompt 304.

The dependency graph 308 may include a visualized depiction of the composition of the computing system 204. For instance, the dependency graph 308 may depict a graph-like structure that indicates the static composition (e.g., all computing resources, computing systems, sub-systems, etc.) and the dynamic composition (e.g., dataflows, relationships, significance levels) of each of the computing resources associated with the computing system 306.

In some implementations, the dependency graph 308 may be or otherwise be stored and managed within a graph database (e.g., a graph-oriented data store). In some implementations, the dependency graph can be updated based on incoming metadata to maintain a current representation of the computing system 306. For instance, the dependency graph 308 may include one or more nodes corresponding to computing resources, infrastructure, sub-systems, etc., and edges indicating the relationships between the computing resources. In this example, the dependency graph 308 may be provided back to the computing device 302 along with one or more fault suggestions 312 as further described herein.

For instance, the generative model 310 may process the user prompt 304 and the dependency graph 308 to generate a fault suggestion 312. In this example, the computing system 306 can determine respective node states of the one or more nodes, where the respective node states can indicate a level of traffic between each of the one or more nodes. The generative model 310, which may be similar to the generative model 208 of FIG. 2, may be configured to determine, based on respective node states, a significance level for each node corresponding to the computing resources

By way of example, the generative model 310 can determine that the respective node states are indicative of a significance score, where the significance score can be computed using one or more scoring algorithms to facilitate the identification of computing resources that are determined to have a high impact on the operation of the computing system 306.

In some implementations, the generative model 310 can utilize a retrieval-augmented generation technique. This can include translating the natural language of the user prompt 304 into a structured query (e.g., a Cypher query for a graph database) to retrieve a relevant subgraph or contextual data from the dependency graph 308. The process can additionally and/or alternatively include identifying a resource type associated with one or more of the computing resources, such as those determined to have a high significance level.

In some, the identified resource type can be associated with one or more fault suggestion recipes accessible by the generative model 310. A fault suggestion recipe may include a modification parameter to modify the computing environment of the computing system 306 in a manner specific to the associated resource type. An example computing environment may include a sub-production environment such as a test, development, or quality assurance (QA) environment. In some implementations, a production environment of the computing system 306 may also be used.

Based on the combined context from the user prompt, the retrieved subgraph, and the applicable fault recipes, the generative model 310 can be configured to generate one or more fault suggestions 312. The fault suggestion 312 can be based on the significance score of at least one node and can be configured to modify a computing environment of at least one computing resource. For instance, the fault suggestion 312 can be formatted as a set of executable command-line interface (CLI) commands or as a structured configuration file (e.g., a JavaScript Object Notation (JSON) file, a YAML file, etc.) that, when applied, implements the suggested modification to the computing environment.

In some implementations, the fault suggestion 312 may be transmitted over one or more networks to the computing device 302 and displayed via a user interface to an associated user. For instance, the fault suggestions 312 may include semantic natural language indicators associated with underlying modifications to the computing environment. By way of example, the fault suggestions 312 may include increasing network traffic to a node serving as a firewall to cause the node to suspend processing for a period of time. Rather than detailing the technical commands associated with increasing the network traffic, the generative model 310 may instead generate a natural language output such as “block incoming requests”. In some implementations, the generative model 310 may generate a context aware command and present the command as an option for the user to execute. In this manner, the technology of the present disclosure may obviate the need for a technical understanding of the computing system 306 (e.g., or technical commands) for users increasing the utility and scope of fault engineering.

Based on the fault suggestion 312, the user may determine subsequent actions to take such as accepting the fault suggestion 312, providing follow up or secondary prompts, etc., to further investigate the resiliency of the computing system 306. An example of a user taking subsequent actions is further described with reference to FIG. 4.

FIG. 4 depicts an example dataflow pipeline 400 according to embodiments of the present disclosure. Although FIG. 4 depicts steps performed in a particular order for purposes of illustration and discussion, the methods of the present disclosure are not limited to the particularly illustrated order or arrangement. The various steps of dataflow pipeline 400 can be omitted, rearranged, combined, and/or adapted in various ways without deviating from the scope of the present disclosure.

Dataflow pipeline 400 is described with an example implementation in which a computing device 402 transmits a user prompt 404 to the computing system 406, and in response to the user prompt 404, the computing system 406 generates a dependency graph 408 detailing the composition of the computing system 406. The user prompt 404 and dependency graph 408 may be input into the generative model 410 to generate one or more fault suggestions 412.

A user associated with the computing device 402 may select one or more fault suggestions 412 sequentially and/or concurrently and inject an engineered fault 414 based on the fault suggestion 412 into the computing system 406 to test a level of resiliency associated with one or more elements of the computing system 406. In this implementation, based on injecting the engineered fault 414, a monitoring system 416 of the computing system 406 may generate metric data 418 that may be used to evaluate the performance of the computing system 406.

For instance, the engineered fault 414 may modify a computing environment of the computing system 406. The monitoring system 416 may generate metric data 418 that is provided as input into the generative model 410 such that the metric data 418 may be transmitted back to the computing device 402 as test results, natural language messages indicating the impacts of the engineered faults, generated visuals (e.g., stable state vs. fault state, etc.), or other curated representations of the metric data 418. In this manner, dataflow pipeline 400 may enable a feedback loop that may be used for system evaluation and training the generative model 410 to generate fault suggestions 412. This metric data 418 can subsequently be provided as feedback to a generative model 410, for instance, as training data used to refine the model's parameters, thereby completing the feedback loop for improving the generation of future fault suggestions. In other examples, the monitoring system 416 may directly provide raw metric data 418 to the computing device 402.

By way of example, a generated fault suggestion 412 can be presented to a user via an interface on the computing device 402. The computing system 406 can be configured to receive a response to the fault suggestion 412 from the computing device 402. For instance, a user can provide an input, such as a confirmation or a selection, that serves as a criterion to proceed with a resiliency test based on the fault suggestion 412. In some implementations, the input may include one or more engineered faults 414.

An engineered fault 414 may include a synthetic fault or issue with the computing system 406, applications running on the computing system 406, a network associated with the computing system 406, or one or more processes of the computing system 406. An example of engineered faults 414 may include, but are not limited to an internal networking issue, a bug in one or more software packages, errors in monitoring network load balancer health, domain name system (DNS) errors, or issues that prevent applications from accessing a database service.

A user may select one or more engineered faults 414 to inject into the computing system 406 sequentially and/or concurrently. Based on receiving the engineered faults 414, the computing system 406 can proceed with implementing the fault suggestion 412 (e.g., or other engineered faults 414) to modify the computing environment. This may include implementing one or more code changes, executing specific, automated actions, such as issuing Application Programming Interface (API) calls or command-line interface (CLI) commands directed to the infrastructure hosting the computing system 406. As one example, implementing the engineered fault 414 can involve programmatically modifying a cloud firewall rule to simulate a network outage or altering a backend service configuration of a load balancer. Such an alteration can, for instance, take a particular server instance (e.g., a virtual machine, a container, etc.) offline, thereby facilitating a test of the failover capabilities of the computing system 406.

Based on implementing the engineered fault, the monitoring system 416 may generate metric data 418 indicating a performance of the impacted computing resource within the modified computing environment. The monitoring system 416 may include software or one or more systems configured to monitor the performance of the computing system. In some implementations, the monitoring system 416 may be configured to monitor specific computing resources indicated by the engineered fault 414.

For instance, the monitoring system 416 may generate metric data 418 by collecting operational data or performance data of the computing system 406. The metric data 418 can be used to quantify the behavior and performance of the computing system under the conditions created by the engineered fault 414. Example metric data 418 may include Hypertext Transfer Protocol (HTTP) server error rates, application response latency, and central processing unit (CPU) utilization. In some implementations, the collected metric data may be evaluated by comparing the metric data 418 responsive to an engineered fault 414 against a pre-defined stable state of the computing system 406. For instance, the stable state may indicate a threshold performance level enabling a quantitative analysis of the impact of the engineered fault 414.

In some implementations, the metric data 418 may be provided to the generative model 410 and provided back to the computing device as a natural language output. In some implementations, the metric data 418 may be used to update the dependency graph 408 depicting updated edges (e.g., relationships), updated node states (e.g., failed or strained computing resources), or other depictions of the impacts of the engineered fault 414. For instance, the updated dependency graph 408 may also be provided to the computing device 402. In other examples, the metric data 418 may be used to further train the generative model 410 to generate fault suggestions 412.

For instance, the computing system 406 may generate, based on the metric data 418, training data for the generative model 410. The generative model 410 may utilize the training data to update one or more parameters. This may include refining the generative model 410 by incorporating observed outcomes of previously implemented fault suggestions 412. Accordingly, the metric data 418 may serve as a training feedback loop for the generative model 410. For instance, this training feedback loop can be implemented as a Reinforcement Learning (RL) fine-tuning process.

By way of example, the metric data 418 can be used to calculate a reward signal. A fault suggestion 412 that successfully identifies a system weakness, as indicated by the metric data 418, can be mapped to a positive reward, which in turn can reinforce the model parameters that led to the fault suggestion 412. This reinforcement can adjust the internal parameters of the generative model 410 and may increase the probability that the generative model 410 will generate similarly effective fault suggestions 412 in subsequent operations. In this example, the training data may include the initial user prompt 404, a dependency graph 408 reflecting the system state, and the resulting metric data 418, which can collectively provide a data point for model refinement.

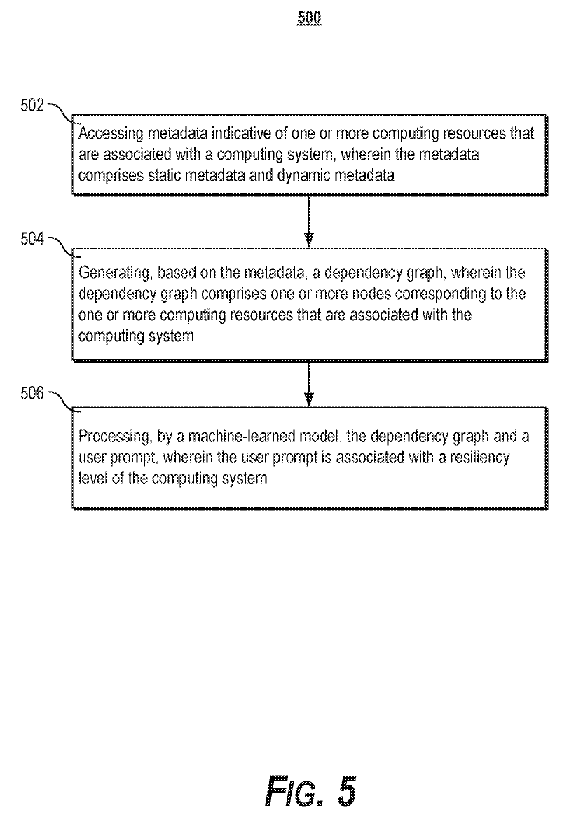

FIG. 5 depicts a flow chart diagram of an example method to generate efficient communications according to example embodiments of the present disclosure. Although FIG. 5 depicts steps performed in a particular order for purposes of illustration and discussion, the methods of the present disclosure are not limited to the particularly illustrated order or arrangement. The various steps of method 500 can be omitted, rearranged, combined, and/or adapted in various ways without deviating from the scope of the present disclosure.

At 502, a computing system can access metadata indicative of one or more computing resources that are associated with a computing system, wherein the metadata includes static metadata and dynamic metadata. In some implementations, the accessed metadata can include static metadata and dynamic metadata, which can be used to provide a representation of the system architecture and operational state. As an example, the static metadata can be determined from an analysis of one or more configuration files or by querying a platform-specific application programming interface (API), such as a cloud asset inventory. In some examples, the dynamic metadata can be determined from an analysis of traffic data (e.g., network flow logs, audit logs) indicative of data packets between the one or more computing resources, where the data may be collected via an ingestion pipeline (e.g., a scheduled serverless execution job) and aggregated in a data storage location (e.g., an object store).

At 504, the computing system can generate, based on the metadata, a dependency graph, wherein the dependency graph includes one or more nodes corresponding to the one or more computing resources that are associated with the computing system. In some implementations, the dependency graph can include one or more nodes corresponding to one or more computing resources associated with the computing system. Generating the dependency graph can include concatenating the static metadata and the dynamic metadata to form a comprehensive data set. As one example, the system can be configured to populate a graph database (e.g., a graph-oriented data store) by parsing the metadata. Within the graph structure, individual computing resources (e.g., a virtual machine, a database, a load balancer, etc.) can be modeled as nodes, and interactions between the resources, which can be derived from sources such as network flow logs and configuration files, can be represented as edges.

In some implementations, the computing system may determine respective node states of the one or more nodes. For instance, the respective node states can indicate a level of traffic between each of the one or more nodes, such as a volume of inbound and outbound data packets. In some embodiments, the respective node states can be indicative of a significance score, where the significance score is computed using one or more scoring algorithms. For instance, a graph-based algorithm (e.g., a PageRank algorithm, a centrality algorithm, etc.) can be executed on the dependency graph to calculate a score for each node.

Based on the respective node states, a significance level of each node can be determined. A node with a high significance score, which can indicate high traffic or a number of dependencies, may be identified as a high-impact component or a potential single point of failure. In some implementations, the dependency graph can be updated based on the metadata to facilitate the model reflecting a current state of the computing system. Furthermore, the system can be configured to determine, based on the metadata, a stable state of the computing system, wherein the stable state can be indicative of a threshold performance level to establish a baseline for resiliency analysis.

At 506, the computing system can process, by a machine-learned model, the dependency graph and a user prompt, wherein the user prompt is associated with a resiliency level of the computing system. In some implementations, the machine-learned model can be a generative model such as machine-learned large language model (LLM). The LLM can be configured to utilize a Retrieval-Augmented Generation (RAG) technique to ground the output in the specific context of the computing system. As part of this technique, the LLM can first process the user prompt, which can be associated with a desired resiliency level, by translating the natural language of the prompt into a structured database query. For instance, where the dependency graph is maintained in a graph database (e.g., a graph-oriented data store), the LLM can be configured to generate a corresponding structured query, such as a Cypher query.

This query can be configured to retrieve a relevant subgraph from the dependency graph, including, for example, nodes with a high significance score. The resulting fault suggestion can, for instance, be based on the significance score of at least one node, which can improve the likelihood that a resiliency test targets impactful components. Based on the retrieved subgraph, the computing system may identify a resource type associated with respective computing resources within that subgraph. For instance, the system can be configured to maintain a library of fault suggestion recipes, where the resource type can be associated with one or more fault suggestion recipes to modify the computing environment.

By way of example, a resource type of “database” can be associated with a recipe to inject network latency, while a resource type of “virtual machine instance” can be associated with a recipe to terminate the instance. In some embodiments, the one or more fault suggestion recipes can include a modification parameter to modify the computing environment based on the resource type, such as a parameter to define a specific latency amount or a specific termination signal.

The LLM can be configured to process the retrieved subgraph, the original prompt, and the applicable fault recipes to generate the final fault suggestion, which can be configured to modify a computing environment of at least one computing resource. The suggestion may be formatted as an executable artifact, such as a set of command-line interface (CLI) commands or a structured configuration file (e.g., a JSON file, a YAML file) for a fault engineering toolkit.

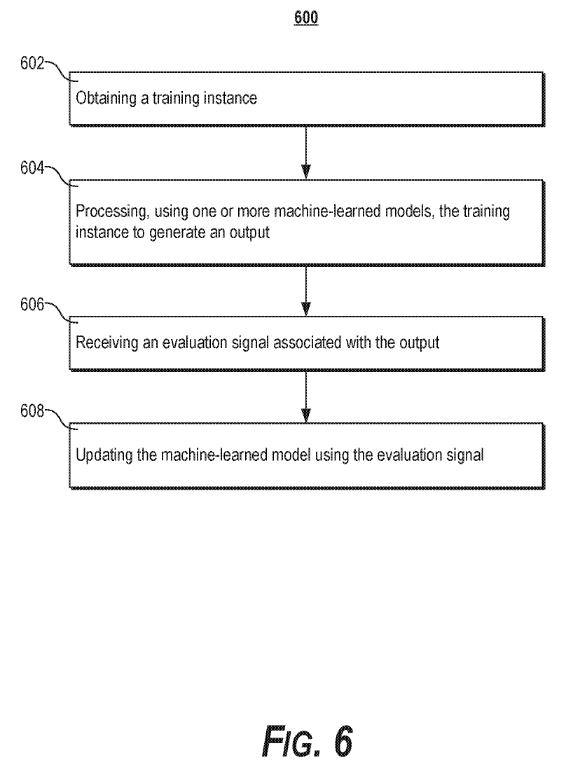

FIG. 6 depicts a flowchart of a method 600 for training one or more machine-learned models according to aspects of the present disclosure. For instance, an example machine-learned model can include a decoder model.

One or more portion(s) of example method 600 can be implemented by a computing system that includes one or more computing devices such as, for example, computing systems described with reference to the other figures. Each respective portion of example method 600 can be performed by any (or any combination) of one or more computing devices. Moreover, one or more portion(s) of example method 600 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of example method 600 can be performed additionally, or alternatively, by other systems.

At 602, example method 600 can include obtaining a training instance. A training data can include a plurality of training instances divided between multiple datasets (e.g., a training dataset, a validation dataset, or testing dataset). A training instance can be labeled or unlabeled. Although referred to in example method 600 as a “training” instance, it is to be understood that runtime inferences can form training instances when a model is trained using an evaluation of the model’s performance on that runtime instance (e.g., online training/learning). Example data types for the training instance and various tasks associated therewith are described throughout the present disclosure.

At 604, example method 600 can include processing, using one or more machine-learned models, the training instance to generate an output. The output can be directly obtained from the one or more machine-learned models or can be a downstream result of a chain of processing operations that includes an output of the one or more machine-learned models.

At 606, example method 600 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 608, example method 600 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 600 can include implementing a number of generalization techniques (e.g., weight decays, dropouts, etc.) to improve the generalization capability of the models being trained.

In some implementations, example method 600 can be implemented for training a machine-learned model from an initialized state to a fully trained state (e.g., when the model exhibits a desired performance profile, such as based on accuracy, precision, recall, etc.).

In some implementations, example method 600 can be implemented for particular stages of a training procedure. For instance, in some implementations, example method 600 can be implemented for pre-training a machine-learned model. Pre-training can include, for instance, large-scale training over potentially noisy data to achieve a broad base of performance levels across a variety of tasks/data types.

In some implementations, example method 600 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 600 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 600 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

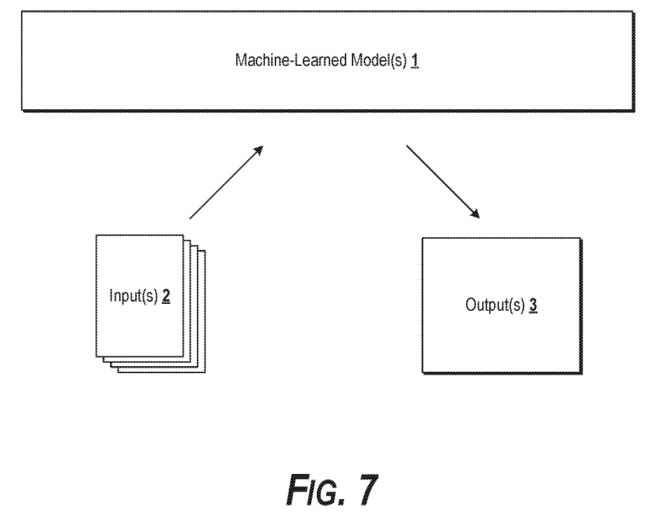

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include or otherwise be representative of any one or more of the machine-learned models described above with respect to the preceding figures. For example, machine-learned model(s) 1 can be or include, or otherwise be representative of any one or more of decoder models, etc. Although various features, variations, and implementations described below are described with respect to machine-learned model(s) 1, it is to be understood that such features, variations, and implementations are to be understood as described with respect to each of decoder models, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single, or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a sub the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

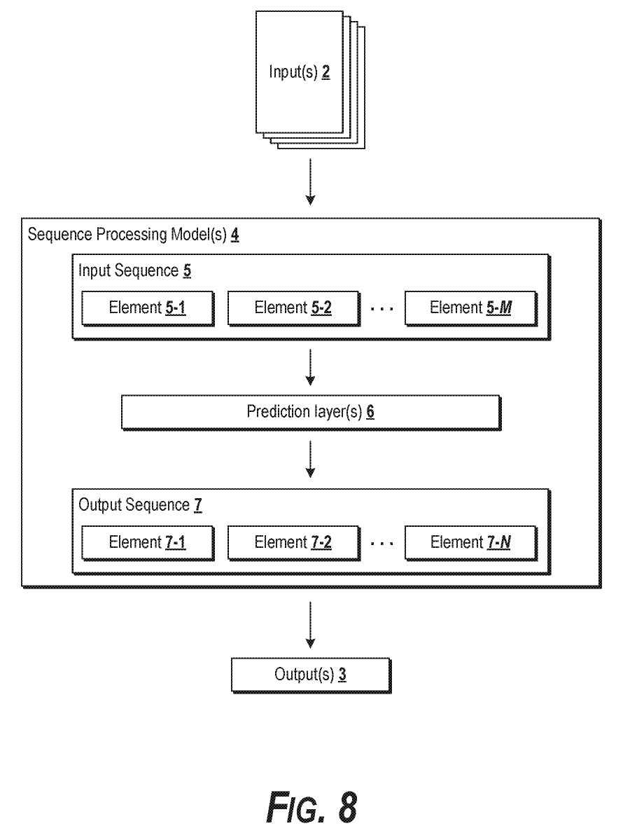

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16x16 Words: Transformers for Image Recognition at Scale, arXiv:2010.11929v2 (Jun. 3, 2021), audio domains, see, e.g., Agostinelli et al., AudioLM: a Language Modeling Approach to Audio Generation, arXiv:2209.03143v2 (Jul. 26, 2023),

, biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66–71 (October 31–November 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 8 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter’s toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a classes into which an input sequence is to be classified. For instance, a vision transformer block can pass latent state information to a multilayer perceptron that outputs a likely class value associated with an input image.

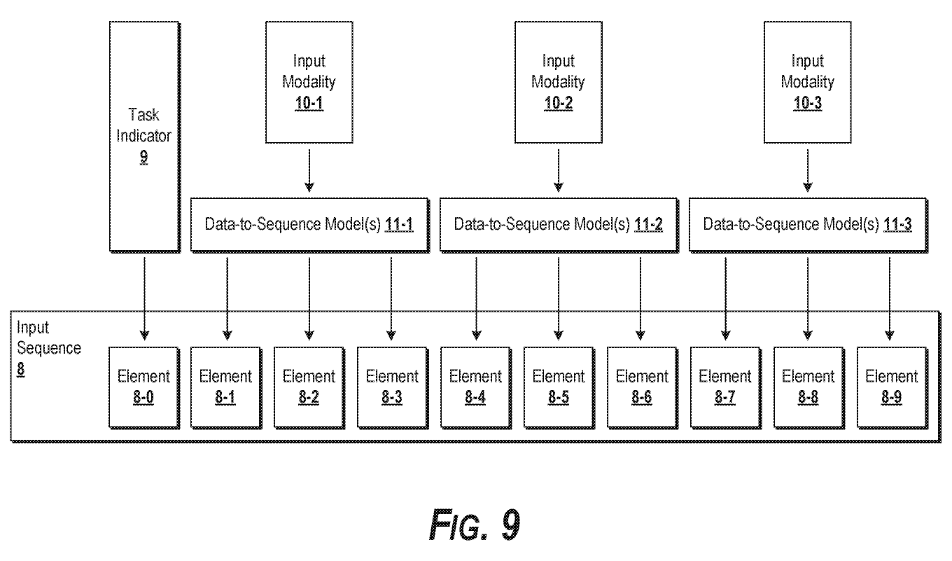

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations there between.

For example, elements 8-0, . . . , 8-9 can indicate particular locations within a multidimensional embedding space. Some elements can map to discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

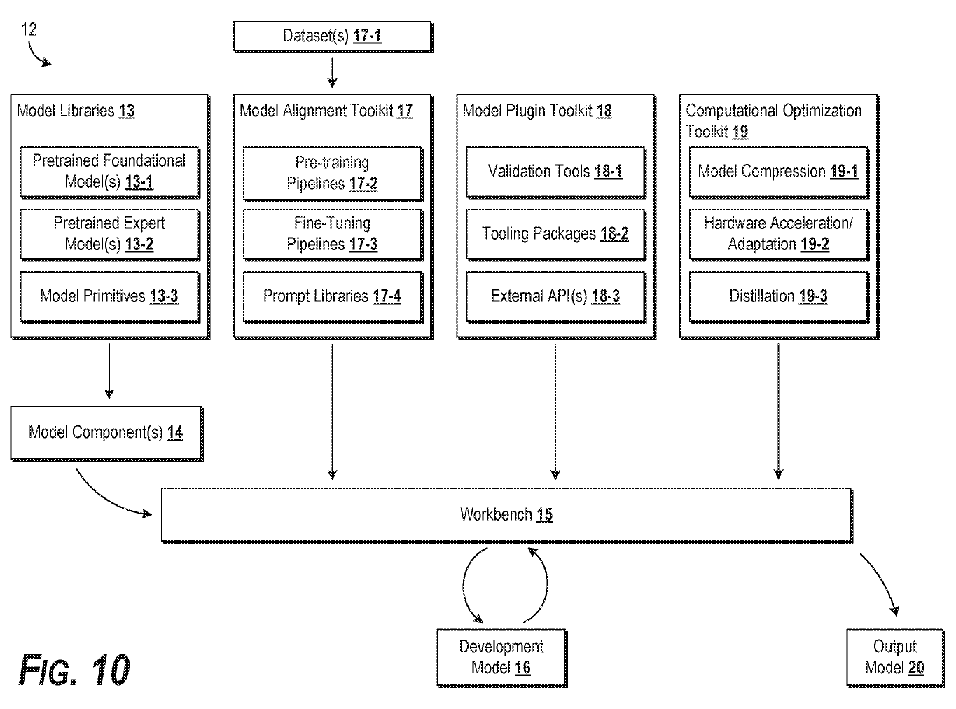

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 600 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

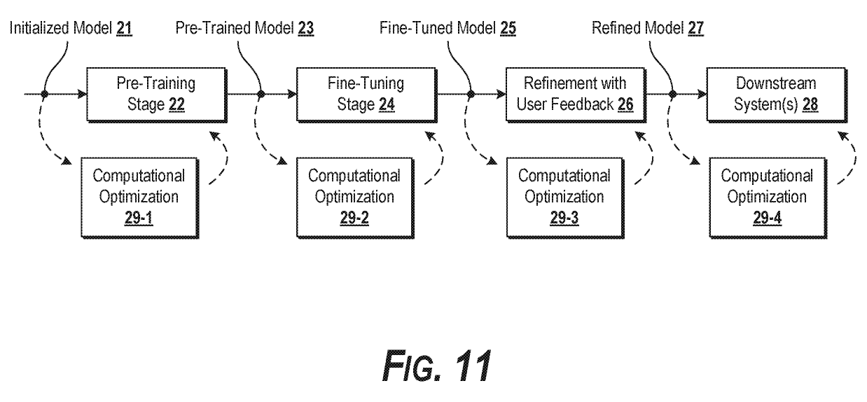

FIG. 11 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of the example training flow can be performed additionally, or alternatively, by other systems.

Initially, development model 16 as described in FIG. 10 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

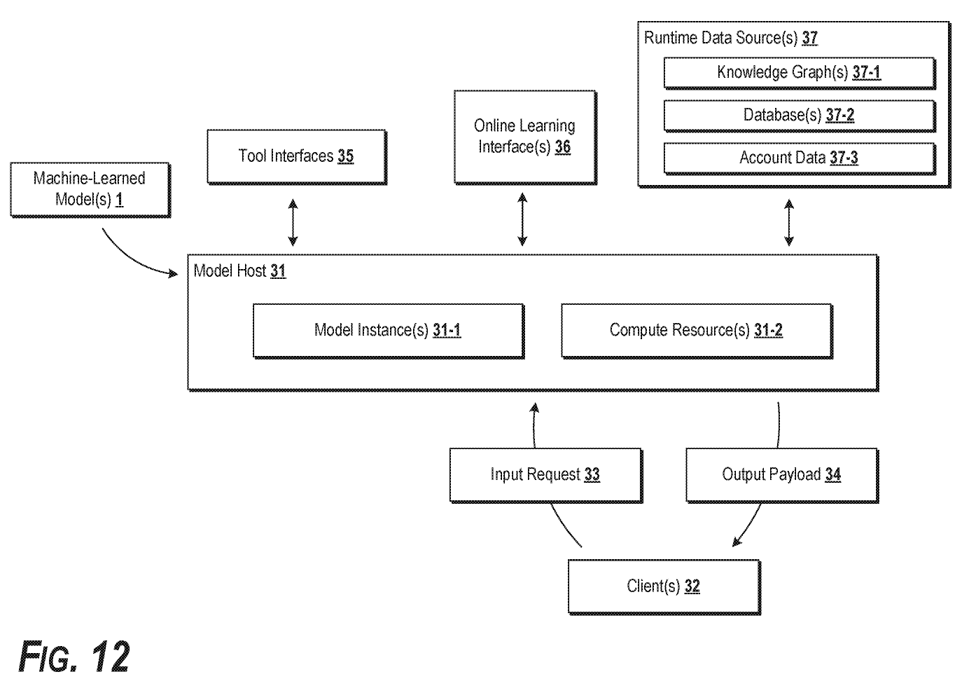

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined categories. For example, the categories can be foreground and background. As another example, the categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

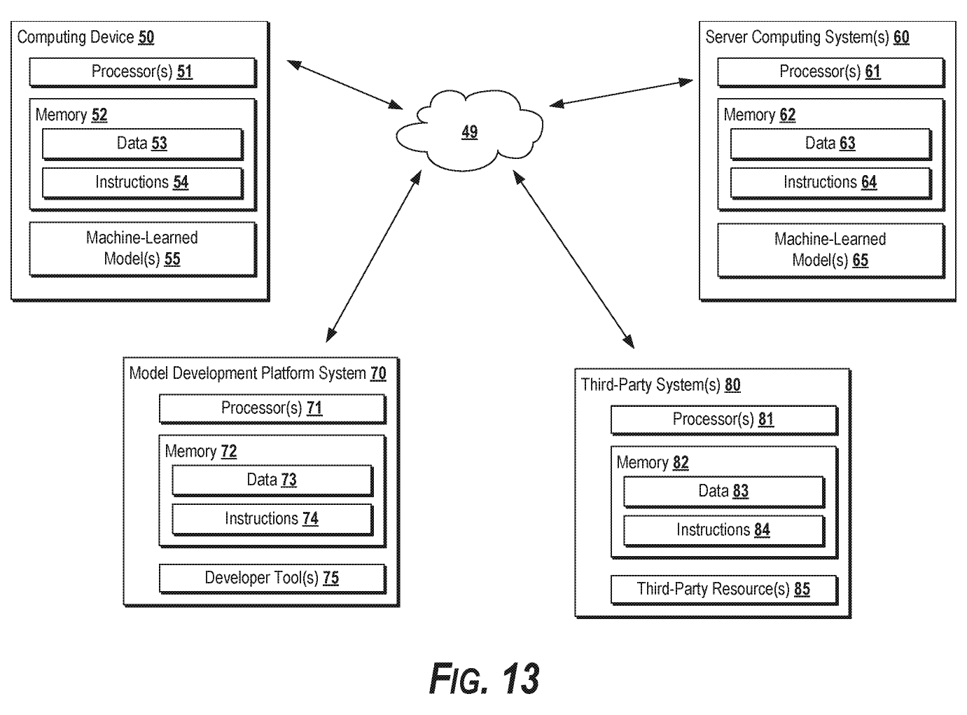

FIG. 13 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 13 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

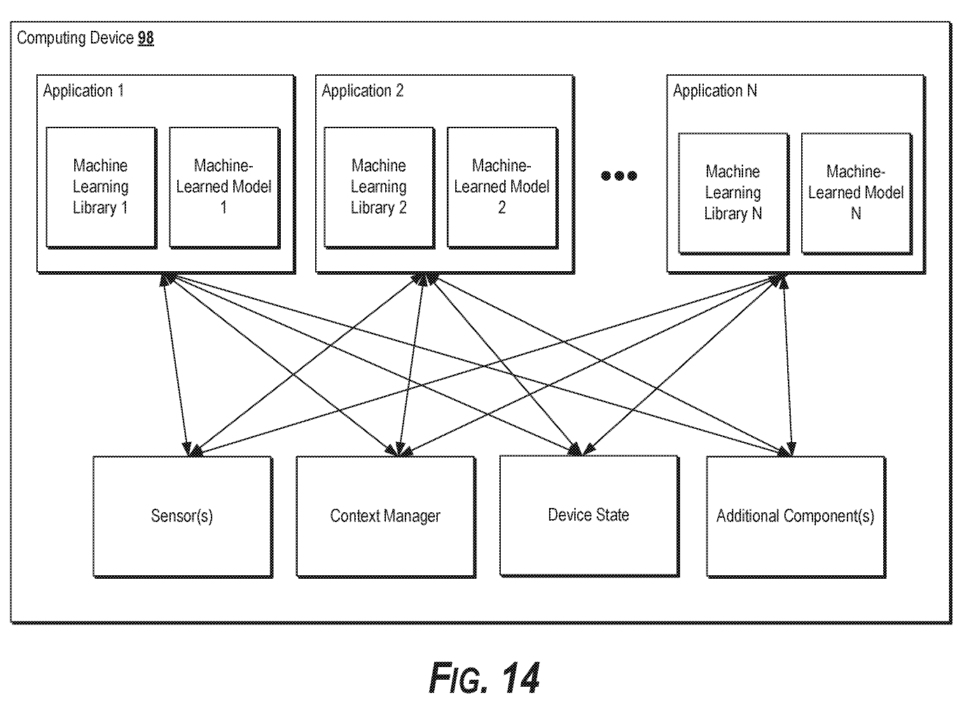

FIG. 14 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

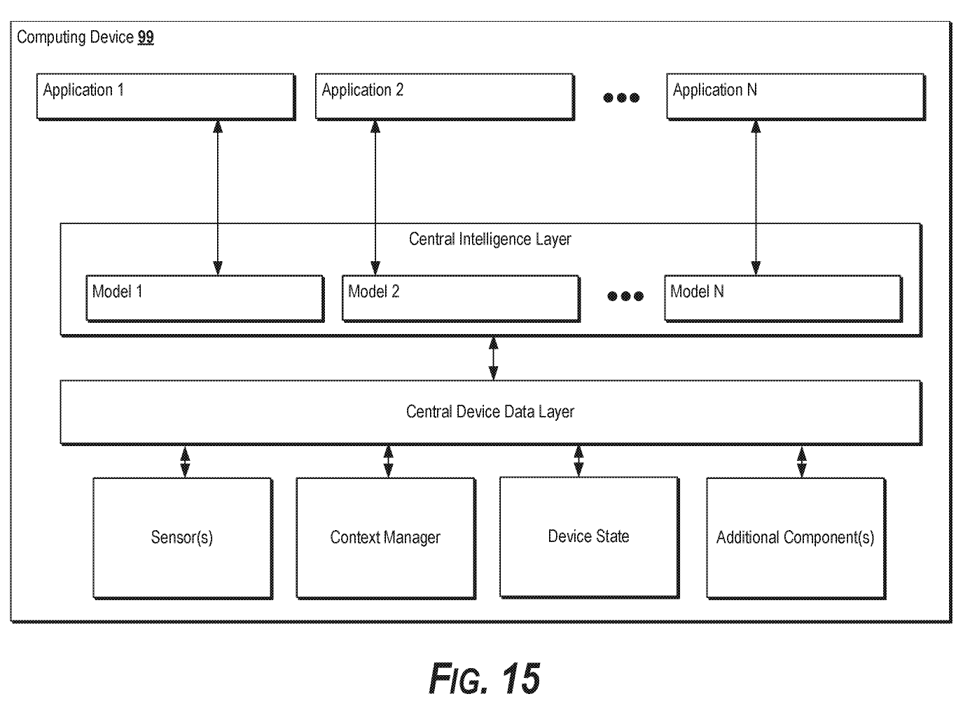

FIG. 15 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 15 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method comprising:
accessing metadata indicative of one or more computing resources that are associated with a computing system, wherein the metadata comprises static metadata and dynamic metadata;
generating, based on the metadata, a dependency graph, wherein the dependency graph comprises one or more nodes corresponding to the one or more computing resources that are associated with the computing system;
processing, by a machine-learned model, the dependency graph and a user prompt, wherein the user prompt is associated with a resiliency level of the computing system; and
generating, by the machine-learned model, a fault suggestion, wherein the fault suggestion is configured to modify a computing environment of at least one computing resource of the one or more computing resources associated with the computing system.

2. The computer-implemented method of claim 1, wherein accessing the metadata comprises:
analyzing configuration data associated with the computing system, wherein the configuration data indicates the one or more computing resources that interact with the computing system; and
determining, based on the configuration data, the static metadata associated with the computing system.

3. The computer-implemented method of claim 2, wherein accessing the metadata comprises:
analyzing traffic data indicative of inbound and outbound data packets between the one or more computing resources that are associated with the computing system; and
determining, based on the traffic data, dynamic metadata associated with the computing system.

4. The computer-implemented method of claim 1, wherein generating, based on the metadata, a dependency graph comprises:
concatenating the static metadata and the dynamic metadata; and
determining respective node states of the one or more nodes corresponding to the one or more computing resources, wherein the respective node states indicate a level of traffic between each of the one or more nodes.

5. The computer-implemented method of claim 4, further comprising:
determining, based on the respective node states, a relevancy level of each node of the one or more nodes corresponding to the one or more computing resources.

6. The computer-implemented method of claim 4, wherein the respective node states are indicative of a relevancy score, the relevancy score computed using one or more scoring algorithms.

7. The computer-implemented method of claim 6, wherein the fault suggestion is based on the relevancy score of at least one node of the one or more nodes.

8. The computer-implemented method of claim 1, wherein the dependency graph is continuously updated based on the metadata.

9. The computer-implemented method of claim 1, wherein the machine-learned model comprises a machine-learned large language model (LLM).

10. The computer-implemented method of claim 1, further comprising:
identifying a resource type associated with each computing resource of the one or more computing resources, wherein the resource type is associated with one or more fault suggestion recipes to modify the computing environment.

11. The computer-implemented method of claim 10, wherein the one or more fault suggestion recipes comprises a modification parameter to modify the computing environment based on the resource type.

12. The computer-implemented method of claim 1, further comprising:
receiving a response to the fault suggestion; and
based on the response implementing the fault suggestion to modify the computing environment of the at least one computing resource.

13. The computer-implemented method of claim 12, further comprising:
generating, based on implementing the fault suggestion, fault metrics indicative of a performance of the at least one computing resource within the modified computing environment.

14. The computer-implemented method of claim 13, further comprising:
generating, based on the fault metrics, training data for training the machine-learned model; and
training, using the training data, the machine-learned model to generate fault suggestions.

15. The computer-implemented method of claim 1, further comprising:
determining, based on the metadata, a stable state of the computing system, wherein the stable state is indicative of a threshold performance level of the computing system.

16. A computing system comprising:
one or more processors; and
a memory storing instructions for execution by the one or more processors to cause the one or more processors to perform operations comprising:
accessing metadata indicative of one or more computing resources that are associated with a computing system, wherein the metadata comprises static metadata and dynamic metadata;
generating, based on the metadata, a dependency graph, wherein the dependency graph comprises one or more nodes corresponding to the one or more computing resources that are associated with the computing system;
processing, by a machine-learned model, the dependency graph and a user prompt, wherein the user prompt is associated with a resiliency level of the computing system; and
generating, by the machine-learned model, a fault suggestion, wherein the fault suggestion is configured to modify a computing environment of at least one computing resource of the one or more computing resources associated with the computing system.

17. The computing system of claim 16, wherein accessing the metadata comprises:
analyzing configuration data associated with the computing system, wherein the configuration data indicates the one or more computing resources that interact with the computing system; and
determining, based on the configuration data, the static metadata associated with the computing system.

18. The computing system of claim 17, wherein accessing the metadata comprises:
analyzing traffic data indicative of inbound and outbound data packets between the one or more computing resources that are associated with the computing system; and
determining, based on the traffic data, dynamic metadata associated with the computing system.

19. The computing system of claim 16, wherein generating, based on the metadata, a dependency graph comprises:
concatenating the static metadata and the dynamic metadata; and
determining respective node states of the one or more nodes corresponding to the one or more computing resources, wherein the respective node states indicate a level of traffic between each of the one or more nodes.

20. One or more non-transitory computer-readable media comprising instructions for execution by a computing system to cause the computing system to perform operations comprising:
accessing metadata indicative of one or more computing resources that are associated with a computing system, wherein the metadata comprises static metadata and dynamic metadata;
generating, based on the metadata, a dependency graph, wherein the dependency graph comprises one or more nodes corresponding to the one or more computing resources that are associated with the computing system;
processing, by a machine-learned model, the dependency graph and a user prompt, wherein the user prompt is associated with a resiliency level of the computing system; and
generating, by the machine-learned model, a fault suggestion, wherein the fault suggestion is configured to modify a computing environment of at least one computing resource of the one or more computing resources associated with the computing system.
